(19) United States
(12) Patent Application Publication
(10) Pub. No.: US 2025/0273701 A1
(43) Pub. Date: Aug. 28, 2025

(54) SEPARATOR FOR ELECTROCHEMICAL DEVICE AND ELECTROCHEMICAL DEVICE INCLUDING THE SAME

(71) Applicant: SAMSUNG ELECTRO-MECHANICS CO., LTD., Suwon-si (KR)

(72) Inventors: Dae Hun JEONG, Suwon-si (KR); Dong Jin KIM, Suwon-si (KR); Sung Han KIM, Suwon-si (KR); Jeong Suong YANG, Suwon-si (KR); Dong Soon WOO, Suwon-si (KR); Sang Hak YOON, Suwon-si (KR); Jae Hyuk JANG, Suwon-si (KR)

(73) Assignee: SAMSUNG ELECTRO-MECHANICS CO., LTD., Suwon-si (KR)

(21) Appl. No.: 19/046,967

(22) Filed: Feb. 6, 2025

(30) Foreign Application Priority Data
Feb. 26, 2024 (KR) 10-2024-0027154

(51) Int. Cl. H01M 8/0263

(52) U.S. Cl. CPC H01M 8/0263

(57) ABSTRACT

A separator for an electrochemical device includes a fluid inlet; a fluid outlet; a plurality of serpentine-type flow paths disposed between the fluid inlet and the fluid outlet; and an auxiliary flow path extending in a first direction and connected to inlets and outlets of the plurality of serpentine-type flow paths, the first direction being a direction from the fluid inlet toward the fluid outlet. The plurality of serpentine-type flow paths include a first serpentine-type flow path and a second serpentine-type flow path, and an inlet and an outlet of the second serpentine-type flow path are disposed closer to the fluid outlet in the first direction, compared to an inlet and an outlet of the first serpentine-type flow path.

### CROSS-REFERENCE TO RELATED APPLICATION(S)

This application claims benefit of priority to Korean Patent Application No. 10-2024-0027154 filed on Feb. 26, 2024 in the Korean Intellectual Property Office, the disclosure of which is incorporated herein by reference in its entirety.

### TECHNICAL FIELD

The present disclosure relates to a separator for an electrochemical device, and the electrochemical device.

An electrochemical device may include a fuel cell generating electrical energy by electrochemically reacting a fuel (hydrogen) and an oxidizing agent (pure oxygen or atmospheric oxygen), an electrolysis cell generating hydrogen and oxygen through electrolysis of water, and the like.

As an example of such an electrochemical device, a solid oxide fuel cell (SOFC) and a solid oxide electrolysis cell (SOEC) may include a cell comprising an air electrode, a fuel electrode, and a solid electrolyte with oxygen ion conductivity, and the cell may be referred to as a solid oxide cell. The solid oxide cell may produce electrical energy through an electrochemical reaction or may produce hydrogen by electrolyzing water through a reverse reaction of a solid oxide fuel cell. In addition, other types of fuel cells or water electrolytic cells, such as a phosphoric acid fuel cell (PAFC), an alkaline fuel cell (AFC), a polymer electrolyte fuel cell (PEMFC), and a direct methanol fuel cell (DMFC), are also used in one form of the electrochemical device.

For the electrochemical device, it is common to use a stack structure in which unit cells are disposed between a pair of separators. Here, a flow path through which fluid may flow is formed in the separator. Water vapor, hydrogen, oxygen gas, and the like, may flow through the flow path of the separator, and a direction, a speed, a flow rate, or the like of the fluid may have a significant impact on performance of electrochemical devices. Accordingly, research has recently been conducted in the field of technology to optimize a size, a shape, or the like of the flow path.

### SUMMARY

An aspect of the present disclosure is to implement a separator for an electrochemical device designed to provide high performance when applied to the electrochemical device.

As a method to solve the above-described problems, the present disclosure proposes a novel structure of a separator for an electrochemical device through an example embodiment, and specifically, the separator includes a fluid inlet; a fluid outlet; a plurality of serpentine-type flow paths disposed between the fluid inlet and the fluid outlet; and an auxiliary flow path extending in a first direction and connected to inlets and outlets of the plurality of serpentine-type flow paths, the first direction being a direction from the fluid inlet toward the fluid outlet. The plurality of serpentine-type flow paths include a first serpentine-type flow path and a second serpentine-type flow path, and an inlet and an outlet of the second serpentine-type flow path are disposed closer to the fluid outlet in the first direction, compared to an inlet and an outlet of the first serpentine-type flow path.

In an embodiment, the auxiliary flow path may include a straight flow path.

In an embodiment, the auxiliary flow path may be parallel to the first direction.

In an embodiment, the auxiliary flow path may be connected to the fluid inlet and the fluid outlet, to have an integral structure.

In an embodiment, the first serpentine-type flow path may be provided as a pair on one side and the other side of the auxiliary flow path.

In an embodiment, an inlet of a serpentine-type flow path disposed closest to the fluid inlet, among the plurality of serpentine-type flow paths, may be connected to the fluid inlet.

In an embodiment, an outlet of a serpentine-type flow path disposed closest to the fluid outlet, among the plurality of serpentine-type flow paths, may be connected to the fluid outlet.

In an embodiment, the auxiliary flow path may be disposed in a central region in a second direction perpendicular to the first direction.

In an embodiment, a symmetrical structure may be formed, based on the auxiliary flow path.

In an embodiment, the plurality of serpentine-type flow paths may include a first flow path in the first direction and a second flow path in a second direction perpendicular to the first direction.

In an embodiment, the second flow path may be provided as a plurality of second flow paths, the first flow path may be connected to the plurality of second flow paths, and the plurality of second flow paths may be connected to the auxiliary flow path.

In an embodiment, the auxiliary flow path may be provided as a plurality of auxiliary flow paths, and the fluid inlet and the fluid outlet may be provided as a plurality of fluid inlets and as a plurality of fluid outlets, respectively, to be connected to the auxiliary flow path.

In an embodiment, the plurality of auxiliary flow paths may be disposed in an outer peripheral region in a second direction perpendicular to the first direction.

In an embodiment, the plurality of serpentine-type flow paths may include a first flow path in the first direction and a plurality of second flow paths in the second direction, the first flow path may be connected to the plurality of second flow paths, and the plurality of second flow paths may be connected to the plurality of auxiliary flow paths.

In an embodiment, the first flow path may be disposed in a central region in the second direction.

In an embodiment, a symmetrical structure may be formed, based on the first flow path.

A width, in a second direction perpendicular to the first direction, of the auxiliary flow path is less than a width, in the first direction, of each of the first serpentine-type flow path and the second serpentine-type flow path.

According to another aspect of the present disclosure, an electrochemical device includes a plurality of separators; and an electrochemical cell disposed between the plurality of separators. At least one of the plurality of separators includes a fluid inlet; a fluid outlet; a plurality of serpentine-type flow paths disposed between the fluid inlet and the fluid outlet; and an auxiliary flow path extending in a first direction and connected to inlets and outlets of the plurality of serpentine-type flow paths, the first direction being a direction from the fluid inlet toward the fluid outlet. The plurality of serpentine-type flow paths include a first serpentine-type flow path and a second serpentine-type flow path, and an inlet and an outlet of the second serpentine-type flow path are disposed closer to the fluid outlet in the first direction, compared to an inlet and an outlet of the first serpentine-type flow path.

### BRIEF DESCRIPTION OF DRAWINGS

The above and other aspects, features, and advantages of the present disclosure will be more clearly understood from the following detailed description, taken in conjunction with the accompanying drawings, in which:

FIGS. 1 and 2 schematically illustrate an appearance of a separator for an electrochemical device according to an embodiment of the present disclosure, and correspond to a perspective view and a plan view, respectively.

FIG. 3 illustrates flow of fluid in the separator of FIGS. 1 and 2.

FIG. 4 is a plan view schematically illustrating an appearance of a separator for an electrochemical device according to a modified embodiment.

FIG. 5 illustrates flow of fluid in the separator of FIG. 4.

FIGS. 6 to 9 illustrate a distribution of a mole fraction of hydrogen and a flow velocity in a separator according to a conventional technology.

FIGS. 10 to 13 illustrate a distribution of a mole fraction of hydrogen and a flow velocity in a separator according to a separator according to an embodiment of the present disclosure.

FIG. 14 is a graph comparing a hydrogen production rate according to a shape of a separator.

FIG. 15 illustrates a water electrolysis device to which a separator according to an embodiment of the present disclosure is applied.

### DETAILED DESCRIPTION

Hereinafter, embodiments of the present disclosure will be described with reference to specific embodiments and the attached drawings. The embodiments of the present disclosure may, however, be exemplified in many different forms and should not be construed as being limited to the specific embodiments set forth herein. Furthermore, the embodiments disclosed herein are provided for those skilled in the art to better explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

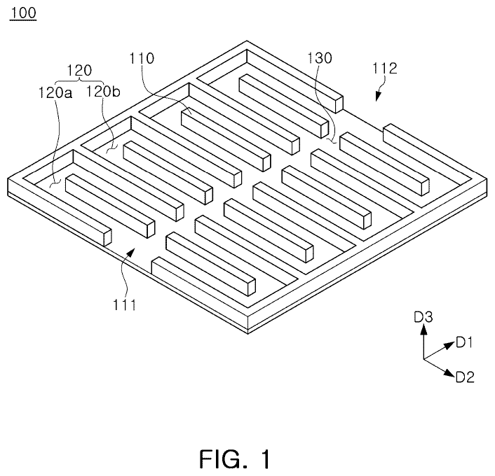

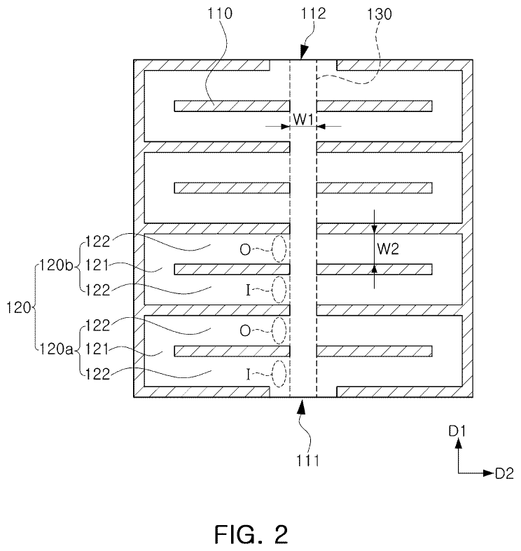

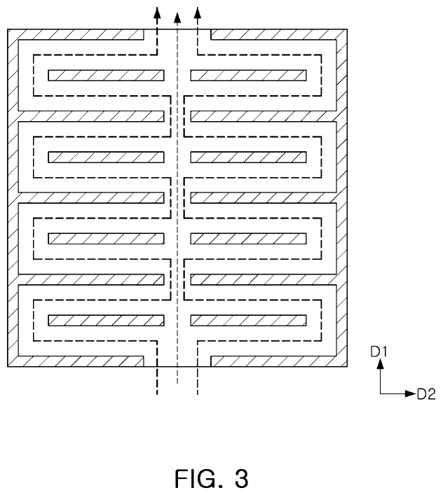

FIGS. 1 and 2 schematically illustrate an appearance of a separator for an electrochemical device according to an embodiment of the present disclosure, and correspond to a perspective view and a plan view, respectively. FIG. 3 illustrates flow of fluid in the separator of FIGS. 1 and 2.

Referring to FIGS. 1 and 2, a separator 100 for an electrochemical device according to an embodiment of the present disclosure (hereinafter, referred to as a “separator for an electrochemical device” or a “separator”) may include a fluid inlet 111, a fluid outlet 112, a serpentine-type flow path 120, and an auxiliary flow path 130. The serpentine-type flow path 120 and the auxiliary flow path 130 may be disposed between the fluid inlet 111 and the fluid outlet 112. In addition, in the serpentine-type flow path 120, an inlet I and an outlet O may be connected to the auxiliary flow path 130, and a second serpentine-type flow path 120b may be disposed relatively closer to the fluid outlet 112 than a first serpentine-type flow path 120a. For example, if a direction from the fluid inlet 111 toward the fluid outlet 112 is referred to as a first direction D1, the inlet I and the outlet O of the second serpentine-type flow path 120b may be disposed closer to the fluid outlet 112, as compared to an inlet I and an outlet O of the first serpentine-type flow path 120a, in the first direction D1. With this type of flow path structure, the separator 100 may have high efficiency when applied to an electrochemical device. For example, when the separator 100 is used in a water electrolysis device, since fuel (e.g., water vapor) may be supplied from the auxiliary flow path 130 to the serpentine-type flow path 120, production efficiency of hydrogen may increase in an overall region of the separator 100. In addition, even when the separator 100 is used in a fuel cell device, since fuel (e.g., hydrogen) may be supplied from the auxiliary flow path 130 to the serpentine path 120, production efficiency of power may increase in an overall region of the separator 100. More detailed descriptions of technical features of the auxiliary flow path 130 and the serpentine path 120 will be described later.

The separator 100 may be a component separating unit cells in the electrochemical device, and may be formed of a conductive material. Specifically, when the separator 100 is used as an SOEC or an SOFC, the separator 100 may include a metal having a high melting point, to not melt or soften at high temperatures. For example, the separator 100 may use a nickel-based material, an iron-based material, a stainless-based material, or the like. In addition, when an operating temperature of the separator 100 is relatively low, for example, at about 800° C. or lower, copper, a copper alloy, or the like having good conductivity may also be used. The separator 100 may include a wall 110 to form a flow path, and may include the auxiliary flow path 130 and the serpentine-type flow path 120, as illustrated. In this case, the fluid inlet 111 and the fluid outlet 112 of the separator 100 do not need to be clearly distinguished from the flow paths 120 and 130, and the fluid inlet 111 and the fluid outlet 112 may not be provided as separate components, but may form a portion of the flow paths 120 and 130. To form the wall 110 in the separator 100, for example, a metal plate may be processed using a stamping process, an etching process, or the like, as an appropriate process. When the separator 100 includes the fluid inlet 111 and the fluid outlet 112, and is used, for example, as a water electrolysis device, water may be injected as water vapor through the fluid inlet 111 and hydrogen gas may be discharged through the fluid outlet 112, and when the separator 100 is used as a fuel cell, the separator 100 may be operated in an opposite manner to what was described above. The fluid inlet 111 and the fluid outlet 112 may be changed, depending on a direction of fluid injection, and accordingly, the inlet I and the outlet O of the serpentine-type flow path 120 may also be changed. Hereinafter, a function of the wall 110 will be described by taking as a main example in a case in which the separator 100 is applied to a fuel electrode of the water electrolysis device. In a case in which the separator 100 is disposed on the fuel electrode of the water electrolysis device, water vapor and a small amount of hydrogen may be injected from the fluid inlet 111, and as the fluid flows along the separator 100, a concentration of the water vapor may decrease and a concentration of the hydrogen may increase. The flow paths of the separator 100 may have functions of supplying reactants while moving a product generated by a reaction therebetween to the fluid outlet 112 to effectively remove the same.

As described above, the separator 100 may include the serpentine-type flow path 120 and the auxiliary flow path 130 connected to the inlet I and the outlet O of the serpentine-type flow path 120. In this case, a boundary between the serpentine-type flow path 120 and the auxiliary flow path 130 may not be clearly distinguished, and the serpentine-type flow path 120 and the auxiliary flow path 130 may be connected to each other to form an integral structure. The serpentine-type flow path 120 may correspond to a main flow path as a curved flow path. In terms of shape, the serpentine-type flow path 120 may include a section in which a fluid path changes at least once. As a specific example, a plurality of serpentine-type flow paths 120 may include a first flow path 121 in the first direction D1 and a second flow paths 122 in a second direction D2. In this case, the second flow path 122 may be provided as a plurality of second flow paths 122, the first flow path 121 may be connected to the plurality of second flow paths 122, and the plurality of second flow paths 122 may be connected to the auxiliary flow paths 130. Although the present embodiment illustrates the serpentine-type flow path 120 in which a fluid path changes twice, the number of sections of changing the fluid path may be 1 or 3 or more. In addition, the serpentine-type flow path 120 in the present embodiment has a region bent at a right angle, but may also have a region bent at a non-right angle or bent to form a curve.

The auxiliary flow path 130 may extend in the first direction D1 as a whole, and may include a straight flow path. Therefore, the auxiliary flow path 130 may induce a fluid path in the first direction D1. The auxiliary flow path 130 does not have to have a single straight shape in an entire region, and there may be a region that deviates from a single straight line in some sections. As a specific example, as illustrated in FIG. 2, the auxiliary flow path 130 may be parallel to the first direction D1. In addition, the auxiliary flow path 130 may be connected to the fluid inlet 111 and the fluid outlet 112 to form an integral structure. As described above, the first direction D1 may be defined as a direction from the fluid inlet 111 to the fluid outlet 112 in the separator 100, but the first direction D1 does not represent only one direction, and may include both directions, e.g., upward and downward directions with respect to FIG. 2. Likewise, the second direction D2, perpendicular to the first direction D1, does not represent only one direction, but may include both directions, e.g., left and right directions, based on FIG. 2. Likewise, a third direction D3, perpendicular to the first and second directions D1 and D2, does not represent only one direction, but may include both directions, e.g., two directions that may be opposite to each other.

In the present embodiment, the serpentine-type flow path 120 may be provided as a plurality of serpentine-type flow paths 120. Specifically, the serpentine-type flow path 120 may include the first and second serpentine-type flow paths 120a and 120b, which may be conveniently named according to the order in which they are disposed based on the fluid inlet 111 and the fluid outlet 112. For example, when naming each of the plurality of serpentine-type flow paths 120, they may be named in order from the closest to the fluid inlet 111, such as the first serpentine-type flow path 120a and the second serpentine-type flow path 120b. In this case, the serpentine-type flow path disposed closest to the fluid inlet 111 among the plurality of serpentine-type flow paths 120, i.e., the first serpentine-type flow path 120a may have the inlet I connected to the fluid inlet 111. In addition, the serpentine-type flow path disposed closest to the fluid outlet 112 among the plurality of serpentine-type flow paths 120, i.e., a serpentine-type flow path disposed in an uppermost portion with reference to FIG. 2 may have an outlet O connected to the fluid outlet 112.

As in the present embodiment, while employing the serpentine-type flow path 120 and the auxiliary flow path 130 in the separator 100, and optimizing arrangement of the serpentine-type flow paths 120, e.g., arranging them in the order of the inlet I and the outlet O of the first serpentine-type flow path 120a, and the inlet I and the outlet O of the second serpentine-type flow path 120b, fuel such as water vapor may be effectively supplied to the serpentine-type flow path 120 through the auxiliary flow path 130 from the fluid inlet 111 to the fluid outlet 112. By re-supply of the fuel, production efficiency of hydrogen may be improved even in a region adjacent to the fluid outlet 111. With reference to FIGS. 2 and 3 in detail, the serpentine-type flow path 120 may correspond to the main flow path, and fuel such as water vapor or the like may exhibit a flow indicated by a thick dotted line. In using only a straight flow path or a serpentine-type flow path like conventional separators, even when both the straight flow path and the serpentine-type flow path are used, and when an arrangement method as in the present embodiment is not used, there may be a problem that production efficiency of hydrogen decreases because a molar fraction of hydrogen as a product continuously increases from a low level as fuel is consumed as the fuel passes through the flow paths. In the present embodiment, to solve the problem, the fuel may be designed to be resupplied from the auxiliary flow path 130 to the serpentine-type flow path 120, more specifically, to the outlet O of the serpentine-type flow path 120 and a region adjacent thereto. Therefore, the mole fraction of hydrogen in the serpentine-type flow path 120 may discontinuously increase, and production efficiency of hydrogen may be improved. In a fuel cell device, a molar fraction of water in the serpentine-type flow path 120 may be discontinuously increased, and production efficiency of power may be improved.

To explain more specific examples of shapes and an arrangement of flow paths of the separator 100, first, the first serpentine-type flow path 120a may be provided as a pair of first serpentine-type flow paths 120a on one side and the other side of the auxiliary flow path 130, respectively. For example, the first serpentine-type flow path 120a may be provided as a pair of first serpentine-type flow paths 120a connected to the auxiliary flow path 130, and may be disposed on left and right sides of the auxiliary flow path 130, respectively, based on FIG. 2. In addition, the second serpentine-type flow path 120b or other additional serpentine-type flow paths may also have the same symmetrical structure. In this case, as illustrated, the auxiliary flow path 130 may be disposed in a central region of the separator 100 in the second direction D2. In addition, the separator 100 may have a symmetrical structure as a whole, centered on the auxiliary flow path 130. In one example, a width W1, in the second direction D2, of the auxiliary flow path 130 may be less than a width W2, in the first direction D1, of each of the first serpentine-type flow path 120a and the second serpentine-type flow path 120b.

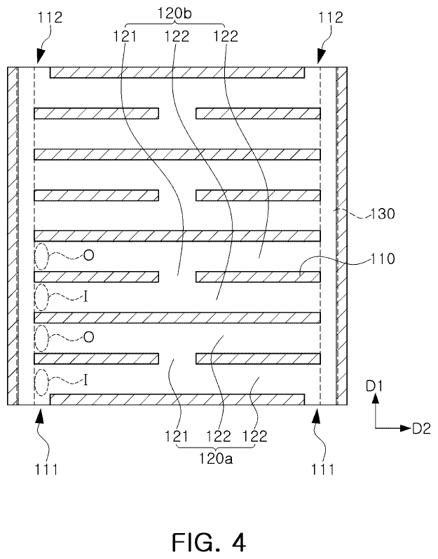

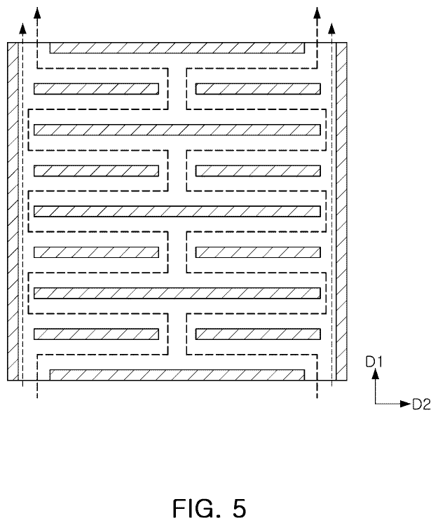

In this manner, in the present embodiment, a separator 100 in which fuel may be replenished from the auxiliary flow path 130 to the serpentine-type flow path 120 corresponding to a main path may be used to improve reactivity of the fuel and production efficiency of products (hydrogen, power, or the like). In addition to the structure illustrated in the above-described embodiment, the serpentine-type flow path 120 and the auxiliary flow path 130 may be disposed in other manners, which will be described with reference to FIGS. 4 and 5. FIG. 4 may be a plan view schematically illustrating an appearance of a separator for an electrochemical device according to a modified embodiment, corresponding to FIG. 2. FIG. 5 illustrates flow of fluid in the separator of FIG. 4, corresponding to FIG. 3. As in the present modified example, an auxiliary flow path 130 may be provided as a plurality of auxiliary flow paths 130. In addition, a fluid inlet 111 and a fluid outlet 112 may be provided as a plurality of fluid inlets 111 and a plurality of fluid outlets 112, respectively, to correspond to the plurality of auxiliary flow paths 130, and furthermore, the fluid inlet 111 and the fluid outlet 112 may be connected to the auxiliary flow path 130. When the plurality of auxiliary flow paths 130 are provided, the plurality of auxiliary flow paths 130 may be disposed in an outer peripheral region in the second direction D2. In addition, a plurality of serpentine-type flow paths 120a and 120b may include a first flow path 121 in the first direction D1 and a second flow path 122 in the second direction D2. In this case, the second flow path 122 may be provided as a plurality of second flow paths 122, the first flow path 121 may be connected to the plurality of second flow paths 122, and the plurality of second flow paths 122 may be connected to the plurality of auxiliary flow paths 130. When the plurality of auxiliary flow paths 130 are disposed in the outer peripheral region in the second direction D2, the first flow path 121 of the serpentine-type flow paths 120a and 120b may be disposed in a central region in the second direction D2. In this case, the separator may have a symmetrical structure as a whole, centered on the first flow path 121.

In the present modified example, fuel may be replenished from the auxiliary flow path 130 disposed on an outside to the serpentine-type flow path 120 corresponding to a main path, and reactivity of the fuel and production efficiency of products (hydrogen, power, or the like) may be improved therefrom.

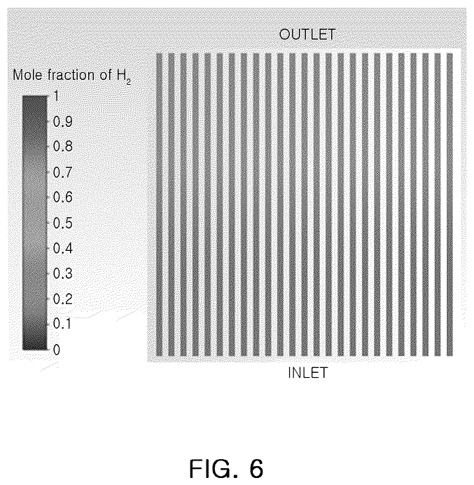

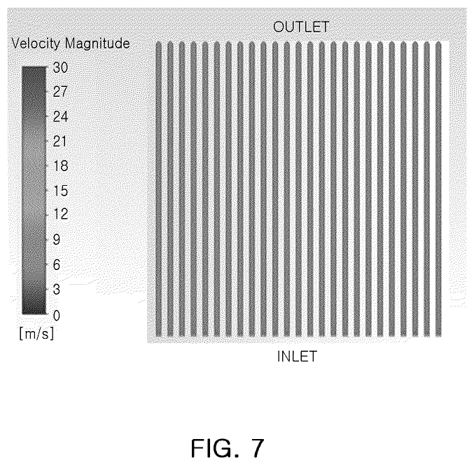

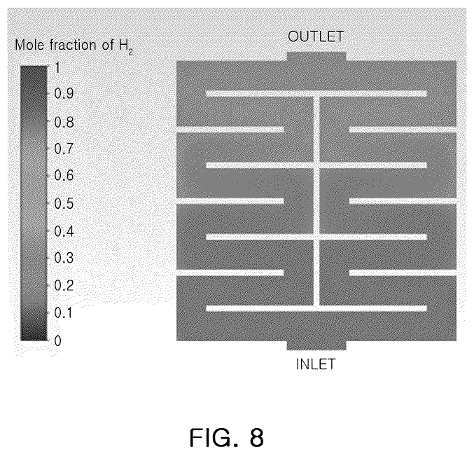

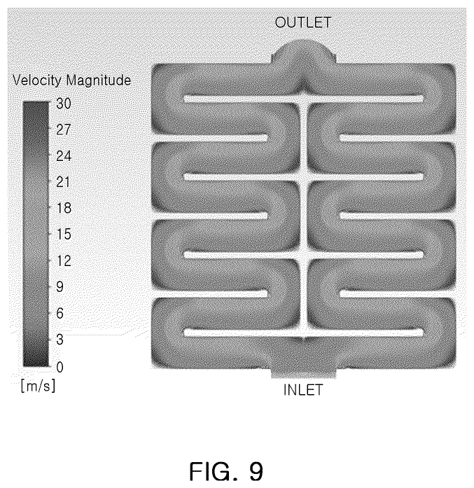

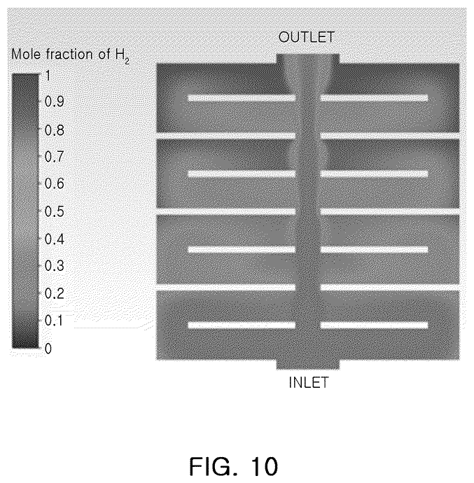

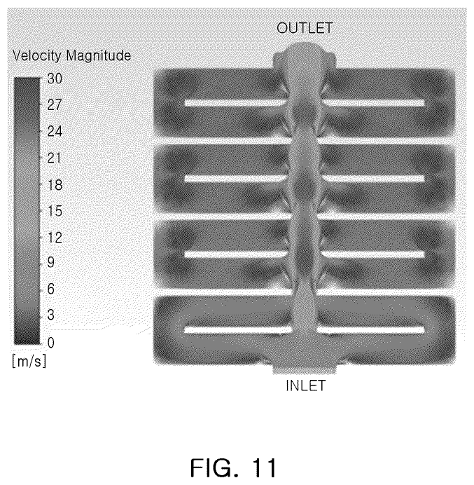

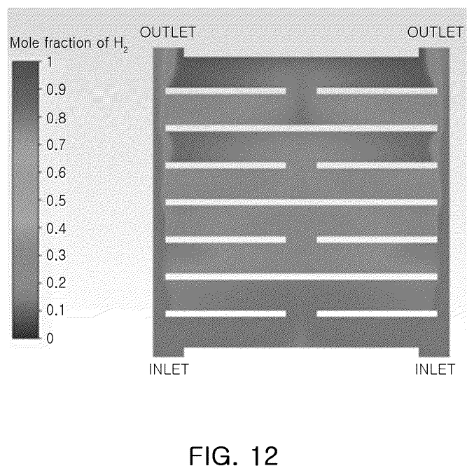

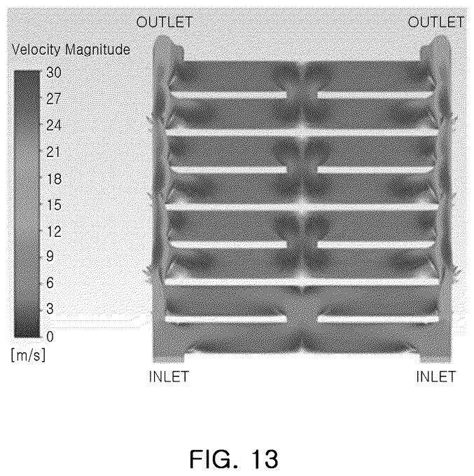

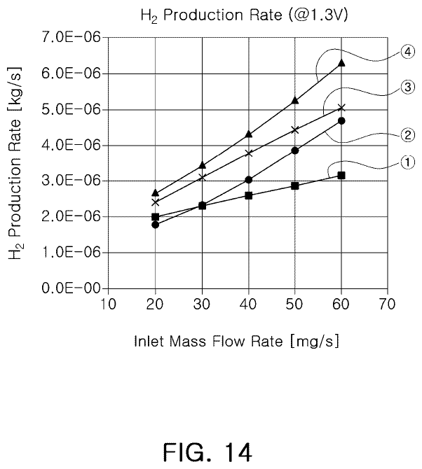

Referring to FIGS. 6 to 14, results of comparing characteristics according to a shape of a flow path of a separator may be described. First, FIGS. 6 to 13 illustrate a distribution of a mole fraction of hydrogen and a flow velocity in a separator according to a conventional technology and a separator according to an embodiment of the present disclosure. In this case, FIG. 6 (hydrogen mole fraction) and FIG. 7 (flow velocity) may be for a separator that only applies a straight flow path, and FIG. 8 (hydrogen mole fraction) and FIG. 9 (flow velocity) may be for a separator that only applies a serpentine-type flow path. FIG. 10 (hydrogen mole fraction) and FIG. 11 (flow velocity) may be for a separator according to the embodiment of FIG. 2, and FIG. 12 (hydrogen mole fraction) and FIG. 13 (flow velocity) may be for a separator according to the embodiment of FIG. 4. In addition, FIG. 14 may be a graph comparing hydrogen production rates according to a shape of a separator, and \textcircled{1} is a result for a separator including only a straight flow path, \textcircled{2} is a result for a separator including only a serpentine-type flow path, \textcircled{3} is a result for a separator according to the embodiment of FIG. 2, and \textcircled{4} is a result for a separator according to the embodiment of FIG. 4.

According to simulation results of FIGS. 6 to 13, in a separator having a composite flow path structure according to an embodiment of the present disclosure, as compared to a separator using only a straight flow path or only a serpentine-type flow path, a mole fraction of hydrogen, which had been increased as fuel was replenished in a region in which the straight flow path and the serpentine-type flow path meet, showed a tendency to decrease again, and accordingly, as can be seen in the graph of FIG. 14, production efficiency of hydrogen by chemical reaction was significantly improved, as compared to the conventional separator.

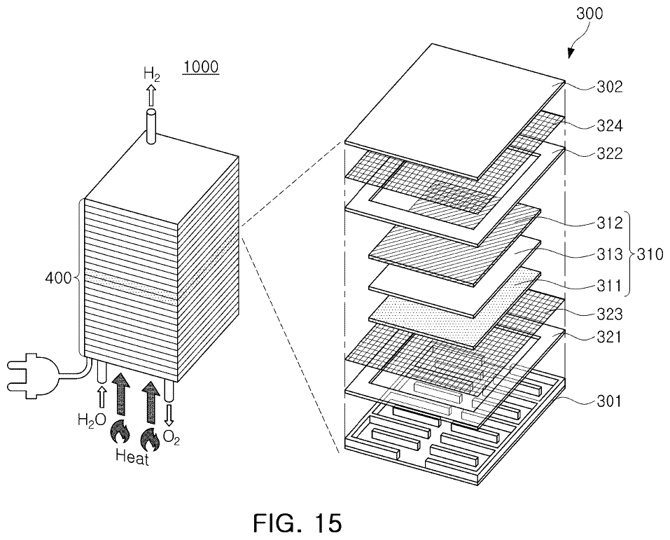

An example of applying the separator described above to an electrochemical device will be described with reference to FIG. 15. FIG. 15 illustrates a water electrolysis device to which a separator having a linear wall is applied. The separator described above may be applied to other types of electrochemical devices such as a fuel cell, not the water electrolysis devices. Referring to FIG. 15, a water electrolysis device 1000 may include a plurality of separators 301 and 302 and an electrochemical cell 310 disposed therebetween. The water electrolysis device 1000 may be supplied with water in a form of water vapor as fuel, and the water may be separated into hydrogen and oxygen by electrolysis. To improve a function of the water electrolysis device 1000, a plurality of units 300 including the separators 301 and 302 and the electrochemical cell 310 may be provided and repeated to form a stack 400. Referring to components of the units 300, the units 300 may include a fuel electrode-side separator 301 and an air electrode-side separator 302. In this case, the fuel electrode-side separator 301 may include a serpentine-type flow path 120 and an auxiliary flow path 130, connected to each other, as described above, and an inlet I and an outlet O of a second serpentine-type flow path 120b may be implemented to be disposed closer to a fluid outlet 112 in the first direction D1 than an inlet I and an outlet O of a first serpentine-type flow path 120a, to improve performance of the water electrolysis device 1000. In FIG. 15, a separator according to the embodiment of FIG. 1 may be used, but a separator according to another embodiment, such as the separator illustrated in FIG. 4, may also be employed. In addition, a shape of the air electrode-side separator 302 is not limited, and a separator, conventionally used, having a straight wall or the like may be used. The air electrode-side separator 302 may also include a flow path having the same shape as the fuel electrode-side separator 301.

For the electrochemical cell 310, as an example, a solid oxide cell may be used. Specifically, the electrochemical cell 310 may include a fuel electrode 311, an air electrode 312, and an electrolyte 313 disposed therebetween. In this case, the fuel electrode 311 may include a cermet layer including a metal-containing phase and a ceramic phase. In this case, the metal-containing phase may include a metal catalyst such as nickel (Ni), cobalt (Co), copper (Cu), alloys thereof, or the like, which acts as an electronic conductor. The metal catalyst may be in a metallic state or may be in an oxide state. The ceramic phase of the fuel electrode 311 may include gadolinia doping seria (GDC), samaria doping seria (SDC), yterbia doping seria (YDC), scandia stabilized zirconia (SSZ), ytterbia ceria scandia stabilized zirconia (YbCSSZ), or the like. The air electrode 312 may include an electrically conductive material, like an electrically conductive perovskite material such as lanthanum strontium manganite (LSM). Other conducting perovskites, metals such as lanthanum strontium cobalt (LSC), lanthanum strontium cobalt manganese (LSCM), lanthanum strontium cobalt ferrite (LSCF), lanthanum strontium ferrite (LSF), La_{0.85}Sr_{0.15}Cr_{0.9}Ni_{0.1}O₃ (LSCN) or Pt may also be used. In some embodiments, the air electrode 312 may include a mixture of an electrically conductive material and an ionically conductive ceramic material. For example, the air electrode 312 may include about 10 wt % to about 90 wt % of the electrically conductive material (e.g., LSM or the like) and about 10 wt % to about 90 wt % of the ionically conductive material. In this case, the ionically conductive material may include a zirconia-based material and/or a ceria-based material. The electrolyte 313 may include stabilized zirconia. Specifically, the electrolyte 313 may include scandia stabilized zirconia (SSZ), yttria stabilized zirconia (YSZ), scandia ceria stabilized zirconia (SCSZ), scandia ceria yttria stabilized zirconia (SCYSZ), scandia ceria yterbia stabilized zirconia (SCYbSZ), or the like.

Although the electrochemical cell 310 is illustrated above as a solid oxide cell, the electrochemical cell 310 may also be employed as a polymer electrolyte membrane cell or the like.

Gaskets 321 and 322 may be disposed on an outside of the electrochemical cell 310 between the separators 301 and 302 to prevent fluid from leaking externally. Additionally, current collector layers 323 and 324 may be disposed between the separators 301 and 302 and the electrochemical cell 310. The current collector layers 323 and 324 may have excellent oxidation resistance to maintain excellent electrical conductivity. Additionally, as illustrated, the current collector layers 323 and 324 may have a porous structure such as a net structure to allow fluid to pass therethrough.

In a separator for an electrochemical device according to an example of the present disclosure, high performance may be provided when applied to the electrochemical device.

While example embodiments have been illustrated and described above, it will be apparent to those skilled in the art that modifications and variations could be made without departing from the scope of the present disclosure as defined by the appended claims.

What is claimed is:

1. A separator for an electrochemical device, comprising:
a fluid inlet;
a fluid outlet;
a plurality of serpentine-type flow paths disposed between the fluid inlet and the fluid outlet; and
an auxiliary flow path extending in a first direction and connected to inlets and outlets of the plurality of serpentine-type flow paths, the first direction being a direction from the fluid inlet toward the fluid outlet,
wherein the plurality of serpentine-type flow paths include a first serpentine-type flow path and a second serpentine-type flow path, and an inlet and an outlet of the second serpentine-type flow path are disposed closer to the fluid outlet in the first direction, compared to an inlet and an outlet of the first serpentine-type flow path.

2. The separator of claim 1, wherein the auxiliary flow path is a straight flow path.

3. The separator of claim 1, wherein the auxiliary flow path is parallel to the first direction.

4. The separator of claim 1, wherein the auxiliary flow path is connected to the fluid inlet and the fluid outlet, to have an integral structure.

5. The separator of claim 1, wherein the first serpentine-type flow path is provided as a pair on one side and the other side of the auxiliary flow path.

6. The separator of claim 1, wherein an inlet of a serpentine-type flow path disposed closest to the fluid inlet, among the plurality of serpentine-type flow paths, is connected to the fluid inlet.

7. The separator of claim 1, wherein an outlet of a serpentine-type flow path disposed closest to the fluid outlet, among the plurality of serpentine-type flow paths, is connected to the fluid outlet.

8. The separator of claim 1, wherein the auxiliary flow path is disposed in a central region in a second direction perpendicular to the first direction.

9. The separator of claim 8, having a symmetrical structure, based on the auxiliary flow path.

10. The separator of claim 1, wherein the plurality of serpentine-type flow paths comprise a first flow path in the first direction and a second flow path in a second direction perpendicular to the first direction.

11. The separator of claim 10, wherein the second flow path is provided as a plurality of second flow paths,
the first flow path is connected to the plurality of second flow paths, and
the plurality of second flow paths are connected to the auxiliary flow path.

12. The separator of claim 1, wherein the auxiliary flow path is provided as a plurality of auxiliary flow paths, and
the fluid inlet and the fluid outlet are provided as a plurality of fluid inlets and as a plurality of fluid outlets, respectively, to be connected to the auxiliary flow path.

13. The separator of claim 12, wherein the plurality of auxiliary flow paths are disposed in an outer peripheral region in a second direction perpendicular to the first direction.

14. The separator of claim 13, wherein the plurality of serpentine-type flow paths comprise a first flow path in the first direction and a plurality of second flow paths in the second direction,
the first flow path is connected to the plurality of second flow paths, and
the plurality of second flow paths are connected to the plurality of auxiliary flow paths.

15. The separator of claim 14, wherein the first flow path is disposed in a central region in the second direction.

16. The separator of claim 15, having a symmetrical structure, based on the first flow path.

17. The separator of claim 1, wherein a width, in a second direction perpendicular to the first direction, of the auxiliary flow path is less than a width, in the first direction, of each of the first serpentine-type flow path and the second serpentine-type flow path.

18. An electrochemical device comprising:
a plurality of separators; and
an electrochemical cell disposed between the plurality of separators,
wherein at least one of the plurality of separators includes a fluid inlet; a fluid outlet; a plurality of serpentine-type flow paths disposed between the fluid inlet and the fluid outlet; and an auxiliary flow path extending in a first direction and connected to inlets and outlets of the plurality of serpentine-type flow paths, the first direction being a direction from the fluid inlet toward the fluid outlet, and
wherein the plurality of serpentine-type flow paths include a first serpentine-type flow path and a second serpentine-type flow path, and an inlet and an outlet of the second serpentine-type flow path are disposed closer to the fluid outlet in the first direction, compared to an inlet and an outlet of the first serpentine-type flow path.
